(19) United States
(12) Patent Application Publication
(10) Pub. No.: US 2001/0049654 A1
(43) Pub. Date: Dec. 6, 2001

(54) System and method for tracking work flow actvities

(76) Inventors: Mark Cecchetti, Erie, PA (US); John Wesley Huegel II, Erie, PA (US); Frank William De Wolf, Erie, PA (US); Jon Michael Colyer, Victor, NY (US)

Correspondence Address: David G. Maire, Esquire, Beusse, Brownlee, Bowdoin & Wolter, P.A., Suite 2500, 390 North Orange Avenue, Orlando, FL, 32801, US

(21) Appl. No.: 09/788,042

(22) Filed: Feb. 17, 2001

Related U.S. Application Data
(63) Continuation-in-part of application No. 09/685,712, filed on Oct. 10, 2000.
(60) Provisional application No. 60/183,203, filed on Feb. 17, 2000.

(51) Int. Cl. G06F 17/60

(52) U.S. Cl. 705/38; 705/26; 705/9; 705/7

(57) ABSTRACT

A computer implemented, web-based system and method of commerce for tracking the work flow activities of a project. For an on-line auction embodiment, the system includes a single web page showing the status of the sequence of procurement activities that must be completed in order to consummate the sale of the items auctioned. Activities are displayed on the single web page in the planned order of completion showing the party responsible for the activity. The status of completion of each activity is indicated by a change in state of a visual indicator associated with each activity. In this manner the status of a plurality of transactions may be presented in an efficient and easily comprehended manner. Hyperlinks to additional web pages may provide the user with additional information regarding the transactions.

This application is a continuation-in-part of co-pending U.S. patent application Ser. No. 09/685,712 filed Oct. 10, 2000. The present invention claims the benefit of U.S. provisional patent application 60/183,203 filed Feb. 17, 2000.

### FIELD OF THE INVENTION

The present invention relates generally to a system and method for tracking work flow activities, and more particularly to a system and method for tracking the status of activities related to a project via a communications network. and specifically to an Internet web page display of the status of purchase and delivery activities which are part of an on-line auction activity.

### BACKGROUND OF THE INVENTION

The development of a global computer network, generally referred to as the Internet or World Wide Web, has given buyers and sellers the opportunity to buy and sell goods between numerous, widely dispersed parties. Many of these opportunities are implemented in auction type scenarios, either direct conventional auctions or in reverse auctions. Conventional auctions are exemplified by eBay, Inc. (http://www.ebay.com); ZD, Inc. (http:I/auctions.zdnet.com) and egghead.com. The system used by egghead.com is described in U.S. Pat. No. 5,835,896. Reverse auctions, in which buyers state a price they are willing to pay for a particular product or service and then sellers decide whether they are willing to provide the product or service at that price, are exemplified by Priceline.com as described in U.S. Pat. No. 5,794,207.

The completion of the auction activity does not constitute the completion of the commercial transaction. After acceptance of an auction bid, there remain the important steps of entering into a purchase agreement such as a purchase order, shipment of the goods, delivery of the goods, receipt of the goods, payment, and possibly others. Various parties to the transaction have responsibility for completion of such steps, and the steps may have to be performed in a specific sequence. The tracking of such activities can become very cumbersome, particularly when a large number of transactions are handled concurrently.

Other types of projects abound where a large number of activities must be completed in a preferred sequence by more than one party in order to complete the project. The communication of the status of these many activities can be very important to the efficient completion of the overall project.

### SUMMARY OF THE INVENTION

Thus there is a particular need for a system and method for the efficient tracking and reporting of the status of multiple activities to be accomplished by multiple parties involved in multiple transactions. Such a system and method should be capable of providing consistent, current information to each of the multiple parties, and should be compatible with on-line commercial transactions. Information should be provided in a clear and easily understood format so that the respective users are able to identify quickly those areas requiring his/her action.

Accordingly, a web-based, computer implemented process is disclosed herein for tracking the work flow activities for a project to communicate completion status of the project to a plurality of parties involved in the project. The method includes generating a plurality of activity management records in a work flow management system; providing a web page output from the work flow management system accessible to a plurality of users via an electronic network; and enabling the web page output to include on a single web page: a listing of a plurality of activities associated with a project; a display responsive to a planned sequence of completion of the plurality of activities; an indication of a party responsible for each respective activity; a completion status indication for each respective activity, the completion status indication being provided by a change in state of a visual indicator associated with each respective activity on the web page; and an indication of activities that remain to be completed for the completion of the project. The visual indicator disclosed herein is a predetermined area on the single web page associated with each respective activity, and a display element positioned in such area indicative of a completion status of the activity.

A computer implemented, internet based commerce system for the auctioning of items among multiple auction parties is further disclosed herein. The system includes: a buyer database containing information about at least one buyer; a supplier database containing information about at least one supplier; an item database containing information about at least one item being exchanged at auction; an bidding database containing bidding information; a communications network interconnecting the buyer database, the supplier database, the item database and the bidding database; and logic operable through the communications database for producing a single web page display of post auction award activity information on a user interface device connected to the communications network, the display comprising: a listing of activities necessary to complete the sale of at least one of the items being auctioned; an indication of a planned sequence of completion of the activities; an indication of a party responsible for each activity; and a visual indicator having a state responsive to a completion status for each respective activity.

### BRIEF DESCRIPTION OF THE DRAWINGS

For a better understanding of the present invention, reference may be had to the following detailed description taking in conjunction with the accompanying drawings in which:

FIG. 1 is a functional block diagram of data structure and flow in an auction system;

FIG. 2 is an illustrative example of a computer screen for use in creating one form of an auction in the system of FIG. 1;

FIG. 3 is an illustrative example of a computer screen for one feature of the auction system;

FIG. 4 is an illustrative example of a computer screen for setting auction parameters;

FIG. 5 is an illustrative example of a computer screen for allowing a third party to confirm participation in an auction of a second party;

FIG. 6 is an illustrative example of a computer screen for enabling a bidder to observe status of bids;

FIG. 7 is an illustrative example of a computer screen for a buyer to observe status of an auction;

FIG. 8 is an illustrative example of a computer screen showing the status of a plurality of activities for a plurality of projects on a single web page, as implemented for the auction system of FIG. 1;

FIG. 9 is a functional flow chart illustrating completion of a contract between parties at completion of an auction.

### DETAILED DESCRIPTION OF THE INVENTION

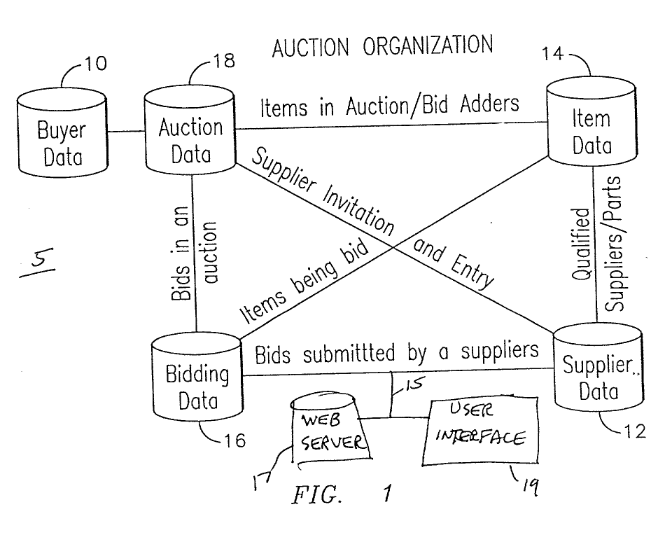

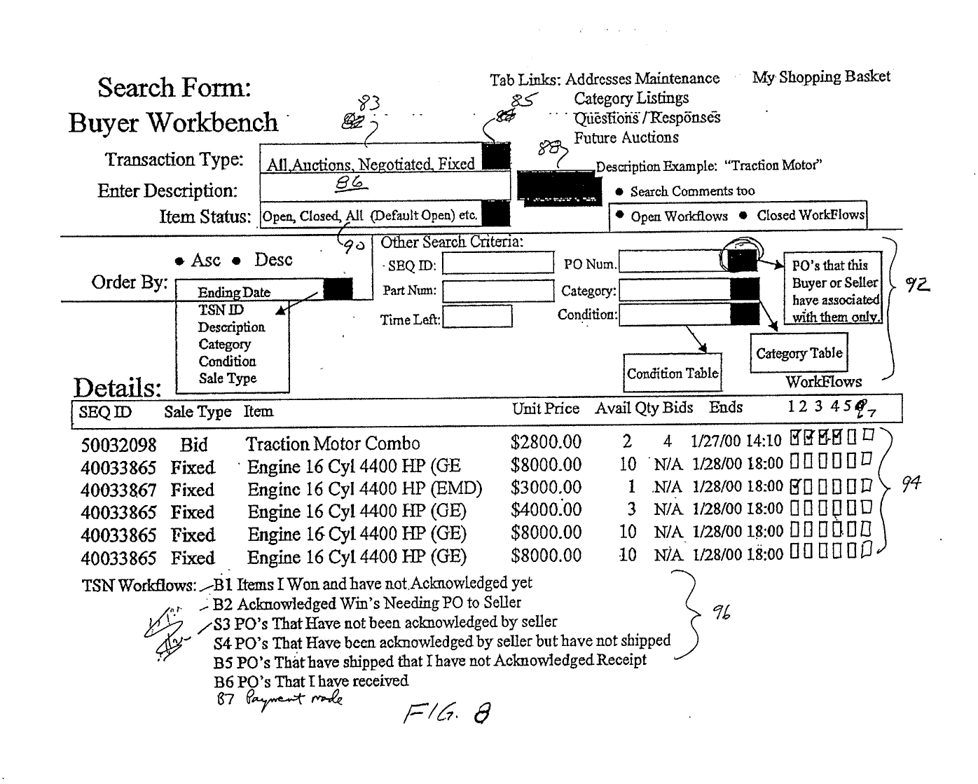

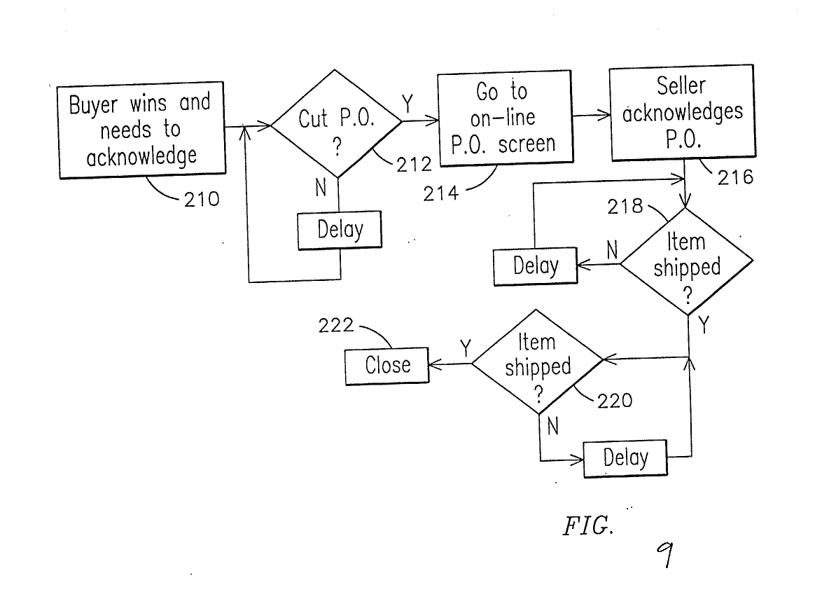

The present invention is illustrated in the embodiment of an on-line auction system. FIGS. 1-7 describe features of such an on-line auction system, and FIG. 8 illustrates a web page of the auction system incorporating inventive work flow tracking features. FIG. 9 illustrates logic utilized to update certain display elements of FIG. 8. While the present invention is described in terms of its use with auctions, it may also be used in traditional purchase order based procurement activities, as well as in other types of multi-task, multi-party functions. Retail applications of the present invention may include, for example, the coordination of a wedding or other social event planning.

FIG. 1 is a schematic representation of the organization of an Internet auction site with which the present invention may be used. The auction site represents a work flow management system 5 that includes several integrated databases that are used during the course of an auction activity. Database 10 stores information about potential buyers who utilize the auction site to purchase goods from suppliers whose data is maintained in a supplier database 12. In addition, the system keeps tracks of information about items being bought and sold in an item database 14 and about bidding information on items involved in an auction in a bidding database 16. Further, there may be included an auction database 18 which keeps track of various administrative functions involved in the auction process. Each of the databases use conventional database software for storing and retrieving data from computer memory.

In the inventive system, a buyer can perform various administrative functions using the auction database 18 to track items which are to be involved in an auction, keep track of who is participating in an auction and who would be invited to participate as a supplier in an auction and also to track bids being made by various suppliers during the course of the auction. The item database 14 can be used to maintain descriptions of items that are being sold or offered for sale or for which a buyer has requested quotes from various suppliers. The item database 14 may include names of the items, a synonym list which provides the ability to give alternate names for the same item and also a list that may provide specifications for particular items. The bidding data in database 16 typically tracks the particular bids being made or offered by suppliers or buyers with regard to items identified by database 14.

It will be noted that each of these databases, 12, 14, 16 and 18 may be integrated with each other on an electronic network 15, such as the Internet, via a web server 17 as is known in the art in order. While a web-based system is described in the context of the Internet, one may appreciate that various other forms of webs may be used to accomplish the necessary communication, for example, wireless, phone/voice, private network, fiber optic, infrared, etc. As will be described more fully below, such integration provides access to the information to a plurality of interested parties through one or more user interface devices 19, for example a personal computer, for tracking and communicating the status of related work flow activities.

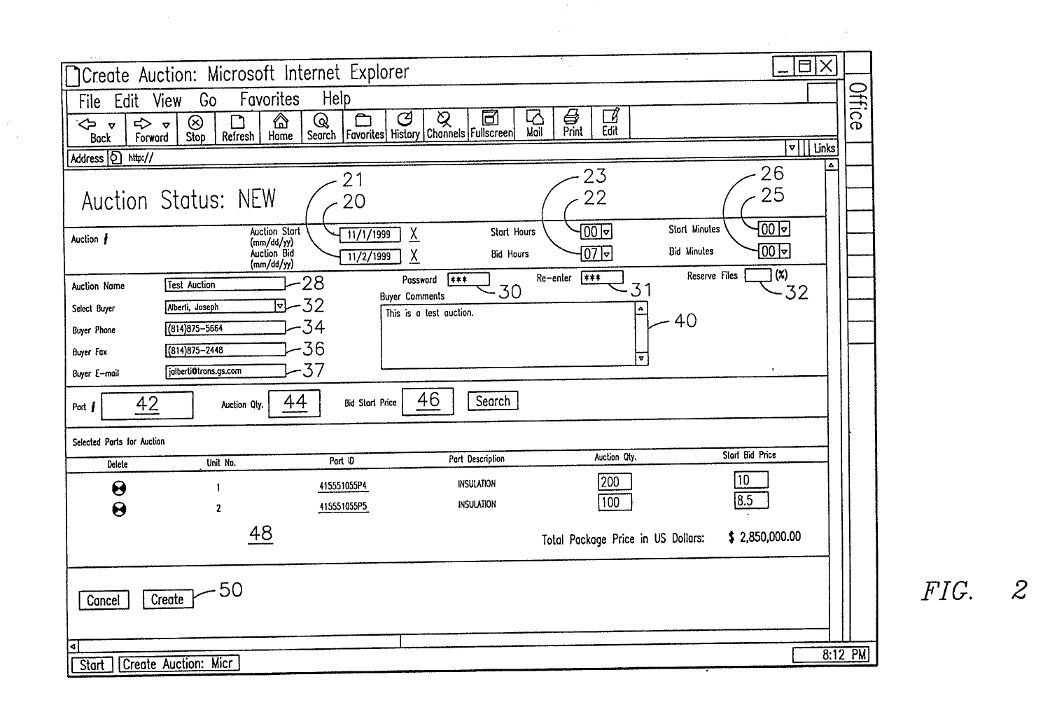

Reference is now made to FIG. 2 which illustrates a screen shot for a buyer to enter data to establish a new reverse auction scenario. In this example, the buyer desires to purchase particular items that may be used in a unique application such as the illustrated insulation for use in a locomotive. The buyer can enter the part number associated with these products where appropriate such as, for example, when the particular insulation product is specifically designed to fit into a particular locomotive, such as a General Electric locomotive. The buyer can initially enter dates on which the auction is to start and when it is to end as shown in blocks 20, 21. The start hours and end hours are then shown in blocks 22, 23. In addition, the system can accept an exact minute for the auction to end at some time other than on an exact hour such as shown by blocks 25, 26. The buyer also has to identify the auction by name for tracking purposes, block 28, and must select a password in order to be able to make further changes in the auction information or to access auction data as shown by blocks 30, 31. If desired, the buyer can enter a reserve price, block 32. Information in blocks 34, 36, 38 and 40 identifies the buyer by name, phone number and e-mail. In block 40, the buyer can enter any comments relating to the particular auction that is being established at this time.

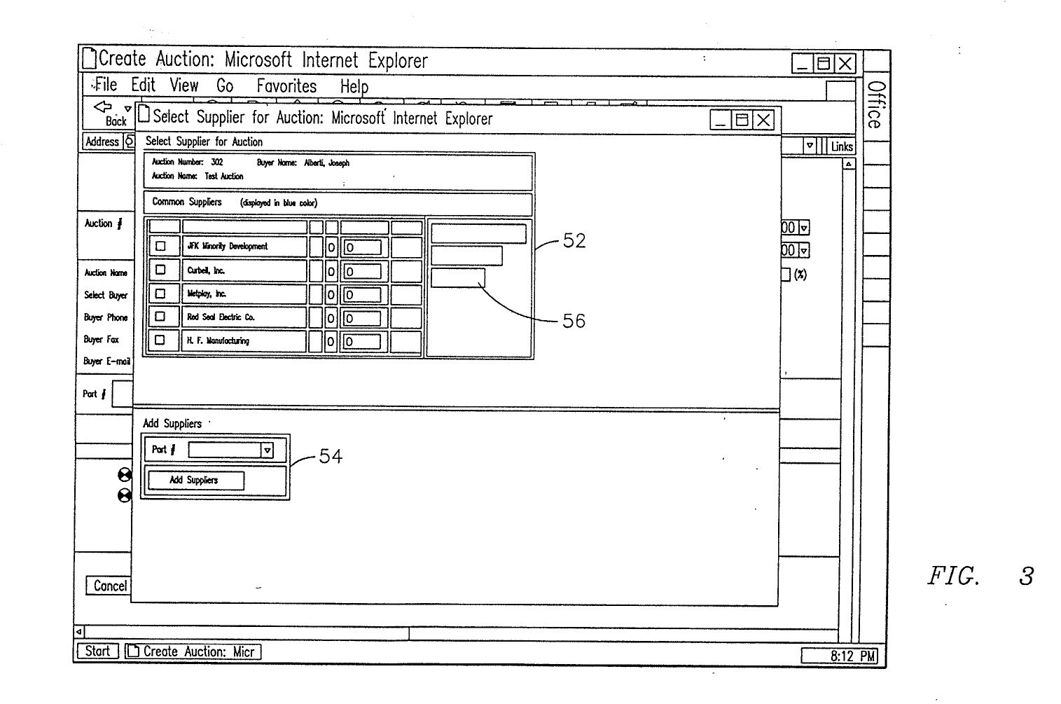

As discussed above, the auction site may be limited to particular types of equipment such as locomotives or off-highway vehicles and as such, certain items for which the buyer is seeking or for which a seller may be trying to sell, can be identified by a part number. Such part numbers can be entered in block 42. The database may be preprogrammed with part numbers so that the buyer may enter only a portion of the part number and then click on a pull-down menu to enter the remaining portion or select the particular part number that he is actually searching for. The buyer can also enter the quantity of parts that he is seeking in block 44. In addition, a seller may want to establish a start price for bidding and such can be entered in block 46. All of this information entered into the blocks 42, 44, and 46 appears in the descriptive area 48 as part ID, part description, auction quantity and start bid price. Once the buyer has finished completing the entries in the box 42, 44 and 46, the buyer can then click on the execute button 50 and the system will proceed to the screen shown in FIG. 3.

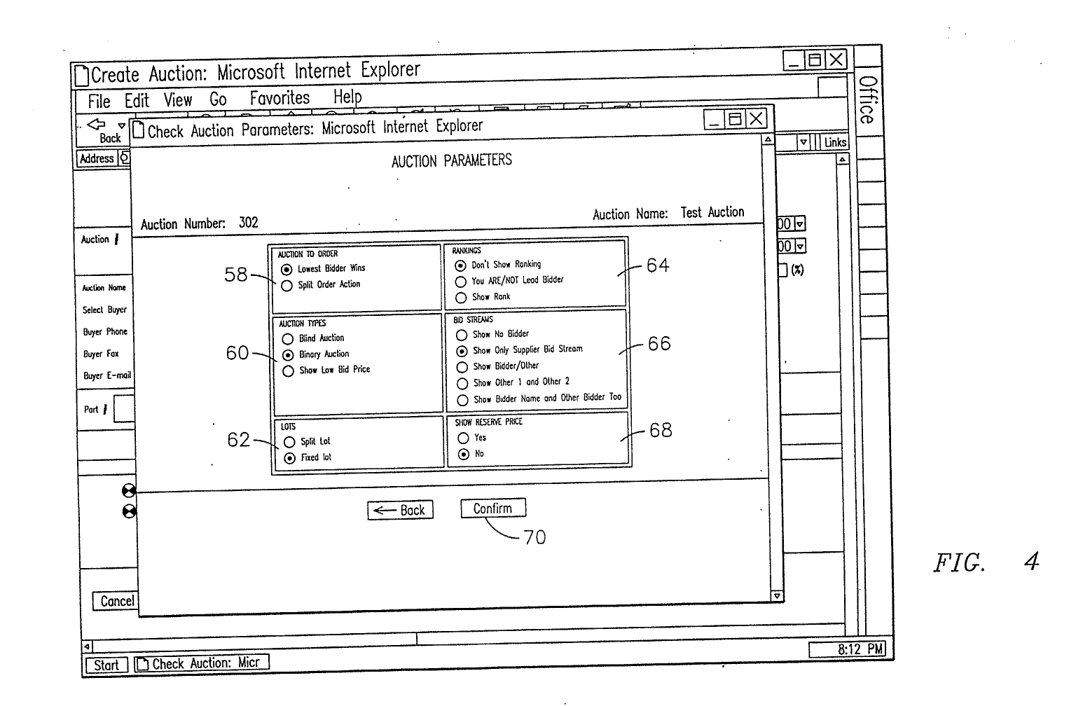

The function identified in the screen of FIG. 3 allows a buyer to select suppliers from a list of available suppliers and thereby excludes other potential suppliers from participating in the auction. In block 52, the buyer merely checks off the names of the suppliers that he wishes to participate with in this reverse auction. In addition, the buyer can add other suppliers that are not in the list in block 54. In the case of additional suppliers added in block 54, the system can e-mail the supplier to notify the supplier that he is being invited to participate in an on-line bidding system for the supply of particular parts to a potential purchaser. Note that the system does not supply the name of the purchaser to any of the potential suppliers. Once all of the suppliers have been identified, the buyer can enter this data by clicking on the execute icon 56. This will bring up the next screen shown in FIG. 4.

As shown in FIG. 4, the auction has been assigned a number and name based on the data input of FIG. 2. In FIG. 4, the buyer is now allowed to select various auction parameters which comprise the administrative functions illustrated by block 18 of FIG. 1. One of the first actions that the buyer can take is to determine the auction order, block 58. One of the options is to allow the lowest bidder to win while another option is to split the order between two or more bidders. The buyer can also select the auction type, block 60 such as a blind auction, a binary auction or show low bid process. Additionally, the buyer can allow a potential supplier to split the required quantity or can only accept bids for the entire lot, block 62. Further buyer options includes the ability to show rankings or positions to potential suppliers, block 64 or show bid streams, block 66. The bid streams block allows the options of not showing any bids, of showing bids only from the particular supplier, showing bids by other suppliers, showing only the first one or two bids and showing the bidder names and other bidders also. Finally, a seller may want to show or not show a reserve price as shown by block 68. Once the auction parameters have been selected, the buyer/seller can click on the execute icon 70.

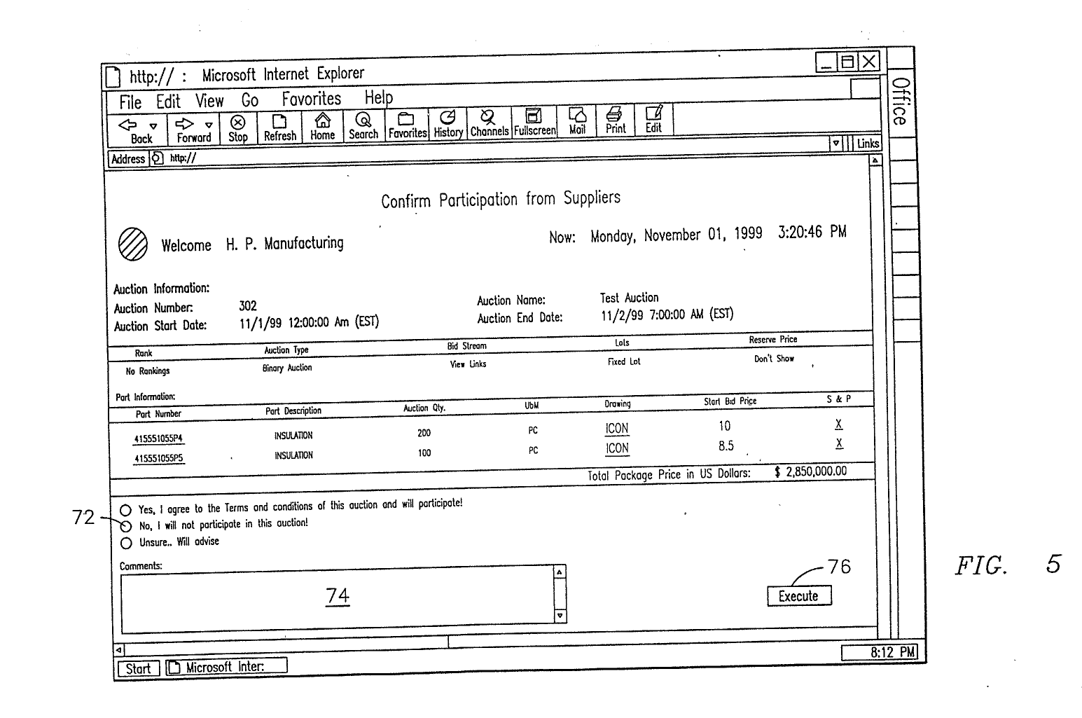

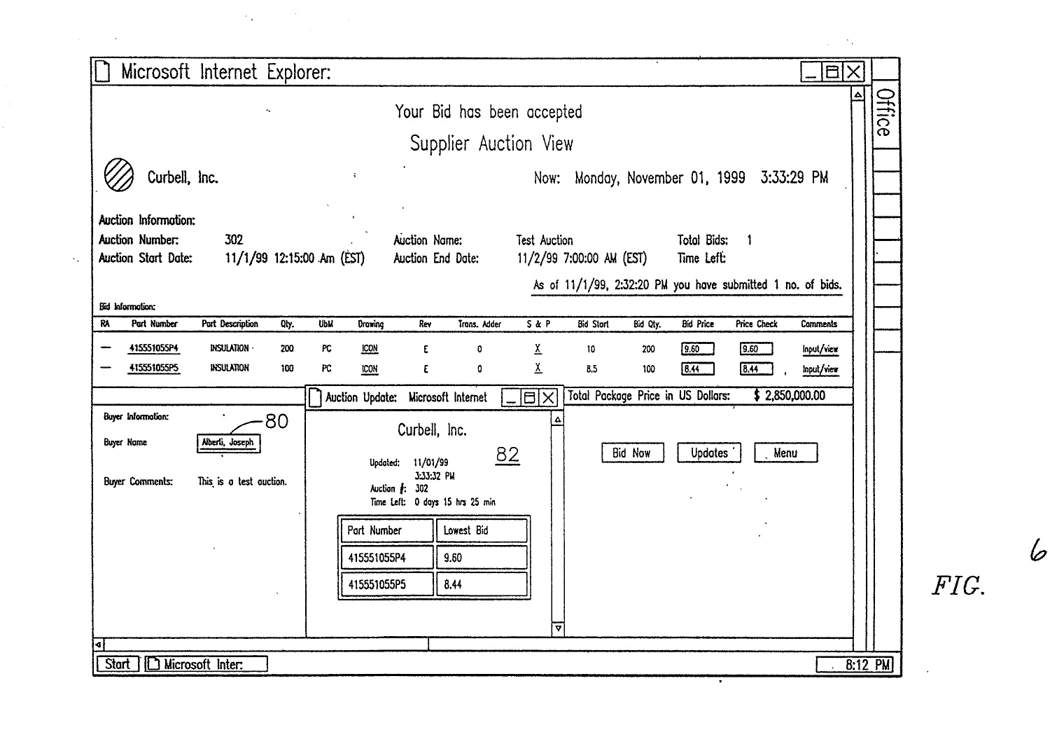

Once the buyer has clicked on the confirmation icon 70 in FIG. 4, the system automatically sends notices to each of the suppliers that the buyer has selected to participate in the auction. When the supplier accesses the auction site, the supplier is presented with the screen of FIG. 5. The screen identifies a particular supplier, the current date and time, the auction information including the type of auction and the parts for which bids are being solicited. The buyer then has the option of electing to agree to the terms and conditions of the auction and participate or to decline to participate. The supplier may also click on the unsure icon, block 72, indicating that the supplier may or may not choose to participate in the auction at some later time. In addition, the supplier may enter any particular comments in the block 74 which can be transmitted to the buyer. Once the supplier has confirmed his participation in the auction, the supplier clicks the execute icon 76 to enter his decision. Turning now to FIG. 6, there is shown a typical screen for a supplier who has made a bid to supply the items requested by the buyer in the exemplary auction. In addition to the general information about the quantities and parts that are up for bid, this screen also provides a continuous update of the time left to participate in the auction and the lowest bid which has been made by a supplier to supply the parts. This screen also supplies the supplier with the current bid price and the lowest bids so that the supplier can determine whether or not his bid needs to be lowered if he desires to participate further in the auction. If the supplier is the winning bidder, then the buyer's name will also appear on this screen at 80. An auction bid report screen shown in FIG. 6. This small screen 82 is updated at regular intervals, typically about every ten seconds and reports the auction number, the time remaining, the items and bid prices, and the bidder's rank in the auction. Since multiple auctions can be in process at the same time, these small windows can be used to watch several auctions and then respond to an auction if action is warranted by the bidder.

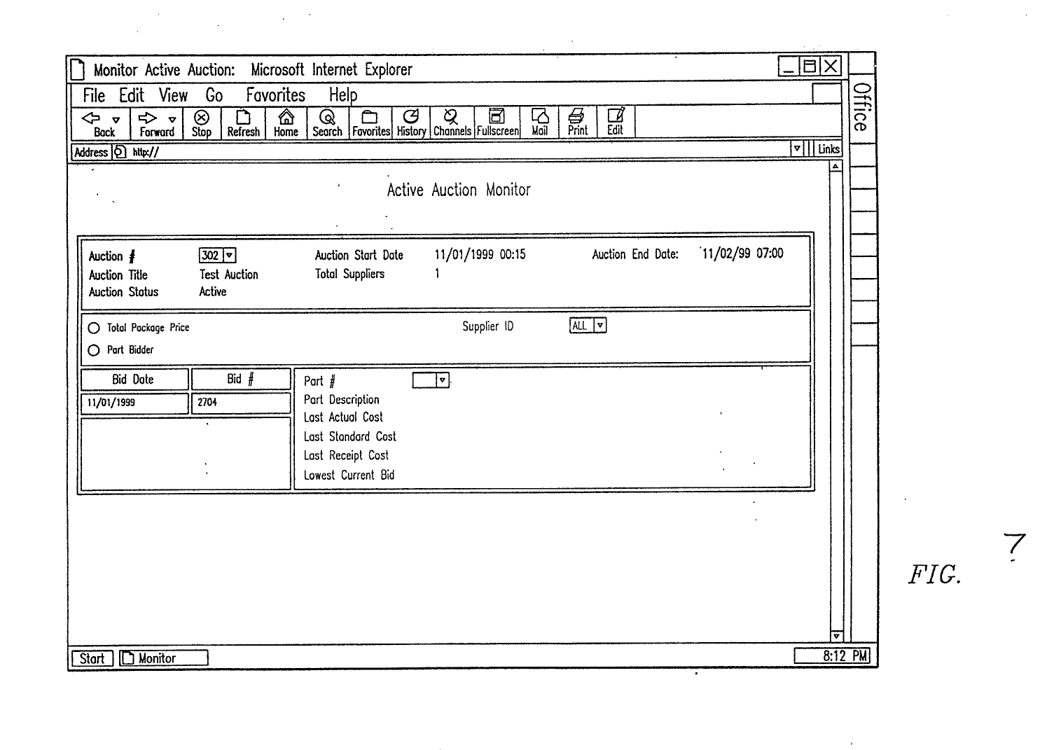

Turning now to FIG. 7, there is shown a sample of the buyer's view of an ongoing auction. In this view, the buyer can actually check the various activities that are going on including monitoring the participants in the auction and the current bids of those participants.

As discussed above, in a reverse auction, the low bidder wins the auction. The low bidder is determined to be the first bidder to enter a low bid that is not beat by another bidder. Some auctions may allow multiple winners or multiple suppliers and in that case the winners can be declared by time of equal low bid placement or by bid amount. In a reverse buy auction, payment from the buyer to the seller results from the execution of the purchase contract which follows the auction and not as a direct result of the auction itself. In a sell auction, payment flows from buyer to seller either through the auction host or directly from the buyer to the seller. In either case, prior art on-line auction systems contain no function to track such post-auction procurement activity.

The invention may also include the ability to award percentages of an auction lot to more than one bidder based on winning bidders rank and a predetermined split table. For example, the buyer may allow the lowest bidder to receive some large percentage of the business, a second bidder to get some lower percentage and a third bidder to get the remainder of the business. This allows the buyer to split up the auction and assure a better flow of supplies or services in response to the auction. Such options further complicate the problem of tracking each of these transactions to final closure upon the completion of the auction.

Whenever an auction is completed, the buyers or sellers are notified that the auction has closed by e-mail. Auction winners are also notified at the same time by e-mail that they have been successful in the auction. Concurrently, the auction creator is notified by e-mail of the winner of the auction so that the buyer and seller can independently contact each other to conclude the transaction. The only funds flow that occurs through the auction may be commissions, selling fees and other fees resulting from usage of the auction service. However, a significant number of post-auction activities must be completed by more than one of the parties in order to consummate the transfer of the item being auctioned. Prior art on-line auction systems have been developed by the auctioning function and accordingly have not been designed to accommodate the management of such activities.

In addition to the tracking functions that are available in the auction system to keep track of bidding on various goods and services through the auction site, the inventive system also provides a follow-up form and tracking function to allow buyers and sellers to keep track of post auction activities. In particular, the system provides a method for tracking activities through the actual delivery, acceptance and payment for the goods and services that are bought and sold through the auction site. Referring now to FIG. 8, there is shown one form of what is referred to as a buyer work bench which enables a buyer to keep track of various items on which he has been the successful bidder. Logic may be provided in the server 17 of FIG. 1 to enable the auction site to provide a status indication to the buyer via user interface device 19 of steps he/she or others need to take to complete the transaction after completion of the auction. The system exemplified by FIG. 8 enables the buyer to have an automated method of tracking purchase and delivery of goods following the auction and can replace the normal paper trails that often exist and create confusion between a buyer and seller. As will be shown, the use of this buyer work bench format through the auction site enables the buyer to quickly determine the status of any deal in which he/she is involved and to communicate that status to a seller or supplier without having to separately provide e-mails or other forms of notification to the supplier.

FIG. 8 represents a screen shot as may be viewed by a buyer on user interface 19. One may appreciate that a similar web page may be enabled for a seller, or a single web page may be made available to all parties to a particular transaction.

The top portion of the form is essentially an information input section which allows the buyer to select the kind of information that he wants to view on this screen. Such capability may be provided via a search function provided on the server 17 in any form of software/logic known in the art of search engines. For example, block 83 allows the buyer to select whether he wants to look at all of his on-going transactions or just some of the transactions by category. Block 83 may be a pull down screen as indicated by the area 85 in which the buyer can then select any of the options available when the screen is pulled down. Optionally, the buyer could simply enter a particular description into block 86 and initiate a search through all of his activities using the pull down screen at 88. Further, the buyer could search by the status of various items as indicated by block 90.

The center section of the screen indicated at 92 includes other kinds of search criteria that may be specified in order to narrow down the particular item that the buyer wishes to have appear on the screen. For example, the buyer can select the display in terms of dates, identification number, description, category, condition, or sale type. Further, the buyer could select search criteria such as the ID, part number, time left to bid, purchase order number, category or condition of the goods. In the present example, the search criteria was selected just to be all in block 83 and as a result the display shows at the lower section indicated by 94 a listing of all of the present deals in which the buyer is involved. At the right hand end of this listing there are a series of blocks under the identifier “work flows”. The work flow blocks are labeled 1-7 and are simply checked to indicate the status of each deal in which the buyer is involved. The status definitions may be any of a plurality of different kinds of definitions but for purposes of this example, the definitions are shown in the area at 96.

Referring to the definitions of the work flow blocks, it will be noted that a check in the first block is an indication that that item is one that the buyer has been successful in purchasing but that he has not acknowledged to the seller that he is the successful bidder. It should also be noted that each of the definitions 1-7 are preceded by a “B” or an “S” indicating whether it is a buyer or seller responsible item. The blocks 1 and 2 are both buyer responses and that the buyer must first acknowledge to the seller that he is the successful bidder and then provide a purchase order to the seller to complete the purchase transaction. The blocks 3 and 4 are checked off to indicate actions that are required by the seller. A check in any of the blocks of column 3 would acknowledge that a purchase order has been issued but that the seller has not responded to the order. A check in any of the blocks under column 4 would indicate that the purchase order has actually been acknowledged by the seller but that the product has not been shipped. Checks in either of blocks 5 and 6 would indicate that the buyer has completed his duties for those blocks such as acknowledging that goods were delivered but that he has not responded to the seller that he has received the goods. Block 6 is the indication that the goods have been received and accepted, and block 7 indicates the payment status. One may appreciate that other related activities may be illustrated in a similar manner.

Thus, the invention provides post auction transaction tracking. Importantly, information related to a plurality of activity management records for one or more projects is displayed on a single web page in a format that efficiently conveys information to the user. In the embodiment illustrated in FIG. 8, one may appreciate that activities 1-7 are arranged from left to right in order of the planned sequence of completion of the activities. Other displays responsive to a planned sequence of completion may be envisioned, for example, top to bottom, inside of a spiral to outside, etc. The listing of various parts may also be displayed in a predetermined sequence. A predetermined area is designated on the single web page for illustrating the completion status of each respective activity via a display element positioned in such area. A change of state of the display element corresponds to a particular completion status. In FIG. 8 a check mark within a rectangle indicates that an activity is completed and an open rectangle indicates that the activity has not yet been completed. Thus, only activities 6 and 7 remain to be completed for the completion of the Traction Motor Combo transaction/project. One may appreciate that other changes of state may be used, for example, a color change including white to black, an end of a bar graph extending, a thermometer rising, a cartoon character changing from sleeping to awake, etc. By grouping the visual indicators in proximity to each other on the single web page and by ordering them in accordance with their planned sequence, the overall status of the project quickly becomes apparent to a user by viewing the state of the proximate display elements. One may envision non-visual indicators, for example sound including voice, being used with the visual indicators or alone to indicate status. For example, a different sound volume may be used to indicate status for work activities having different degrees of importance to a project. The status of more than one project may similarly be displayed on a single web page, as illustrated by the display of six different auction items on FIG. 8.

One or more hyperlinks may be provided on the single web page to provide links directed to other web pages or other portions of the same single web page containing information related to the project. For example, the words “Traction Motor Combo” may be designated as a hyperlink to a technical description of this part, in a manner well known in the art of web design.

The web-based system of the present invention may include an Internet site integrated with a major supplier so that management and logistics for transportation of inventory, processing and tracking shipments and reducing the costs of transportation can be achieved. The inventive system is implemented on an Internet accessible web site and provides search engine capability for locating items of interest, for identifying buyers and sellers of various items, and for selecting the format for display of work flow activities on the web site. The actual buy or sell transaction can be handled off-line after completion of all negotiations in the on-line process with the status of such off-line activities being displayed on-line. Alternatively, such negotiations and the documentation thereof, such as the issuance and acceptance of purchase orders, the completion of delivery forms, etc., may be handled completely on-line. For example, one of the hyperlinks provided on the single web page of FIG. 8 may be to a standard purchase order form which can be completed, delivered, accepted and acknowledged via a shared web site access or via e-mail.

Turning now to FIG. 9, there is shown a process of ending a bidding sequence in which the buyer has won and needs to acknowledge the winning bid, block 210. The system has an option, block 212, for jumping directly into an on-line purchase order screen, block 214, or the buyer can simply cut his own purchase order. If the buyer elects to use the on-line screen, the system goes directly to that screen and issues a purchase order over the Internet to the seller, and the state of the corresponding display element of FIG. 8 may be changed automatically. Once the seller has received the purchase order, block 216, the system keeps track of the status of events monitoring whether or not the item has been shipped, block 218. Once the buyer notifies the system that the item has been shipped, the system then begins to check for acknowledgement from the buyer that the item has been received, block 220. Once the buyer acknowledges receipt, the system then closes the entire event process, block 222. Such steps may be most efficiently communicated and displayed on a single web page as described above in regard to FIG. 8.

While the invention has been described in what is presently considered to be a preferred embodiment, many variations and modifications will become apparent to those skilled in the art. Accordingly, it is intended that the invention not be limited to the specific illustrative embodiment but be interpreted within the full spirit and scope of the appended claims.

What is claimed is:

1. A web-based, computer implemented process for tracking the work flow activities for a project to communicate completion status of the project to a plurality of parties involved in the project, the method comprising:
generating a plurality of activity management records in a work flow management system;
providing a web page output from the work flow management system accessible to a plurality of users via a communications network; and
enabling the web page output to include on a single web page:
a listing of a plurality of activities associated with a project;
a display responsive to a planned sequence of completion of the plurality of activities;
an indication of a party responsible for each respective activity;
a completion status indication for each respective activity, the completion status indication being provided by a change in state of a visual indicator associated with each respective activity on the web page; and
an indication of activities that remain to be completed for the completion of the project.

2. The process of claim 1, wherein the visual indicator comprises a predetermined area on the single web page associated with each respective activity, and a display element positioned in such area indicative of a completion status of the activity.

3. The process of claim 1, further comprising providing at least one hyperlink on the single web page directed to a second web page containing information related to the project.

4. The process of claim 1, further comprising providing a web page output from the work flow management system including a listing of a plurality of activities associated with a plurality of associated projects on the single web page.

5. The process of claim 4, further comprising providing a search engine function accessible to the plurality of users via the electronic network and selectively displaying information on the single web page in a format responsive to a user selected criteria.

6. A web based activity tracking system comprising:
a server;
a plurality of user interface devices connected to the server via a communications network;
logic resident on the server adapted to produce a web display accessible by the plurality of user interface devices, the web display comprising a single web page containing:
a listing of a plurality of activities associated with at least one project;
an indication of a planned sequence of completion of the activities;
an indication of a party responsible for each activity;
an indication of a completion status for each activity, the indication comprising a change in state of a visual indicator representative of the completion status.

7. The web based tracking system of claim 6, wherein the indication of a completion status further comprises a predetermined area on the single web page associated with each respective activity, and wherein the change in state of a visual indicator comprises a display element in the predetermined area.

8. The web based tracking system of claim 6, further comprising an indication on the single web page of activities that remain to be completed for the completion of a project.

9. The web based tracking system of claim 6, further comprising at least one hyperlink on the single web page directed to a second web page containing information related to the at least one project.

10. The web based tracking system of claim 6, further comprising a search capability resident on the server for manipulating the single web page web display in response to a user selected criteria.

11. A computer implemented, internet based commerce system for the auctioning of items among multiple auction parties, the system comprising:
a buyer database containing information about at least one buyer;
a supplier database containing information about at least one supplier;
an item database containing information about at least one item being exchanged at auction;
an bidding database containing bidding information;
a communications network interconnecting the buyer database, the supplier database, the item database and the bidding database; and
logic operable through the communications database for producing a single web page display of post auction award activity information on a user interface device connected to the communications network, the display comprising:
a listing of activities necessary to complete the sale of at least one of the items being auctioned;
an indication of a planned sequence of completion of the activities;
an indication of a party responsible for each activity; and
a visual indicator having a state representative of a completion status for each respective activity.

12. The system of claim 11, wherein the display further comprises:
a predetermined area on the single web page associated with each respective activity, the predetermined areas being arranged on the single web page in an order responsive to the planned sequence of completion; and
a display element associated with each predetermined area and having a state representative of the completion status of the respective activity.

13. The system of claim 12, wherein the listing of activities necessary to complete the sale comprises acceptance of contract of sale, shipment of item, delivery of item, acceptance of delivered item, and payment.

14. The system of claim 13, further comprising a hyperlink on the single web page directed to a second web page including a purchase order form.
